(19) United States
(12) Patent Application Publication
(10) Pub. No.: US 2021/0398429 A1
(43) Pub. Date: Dec. 23, 2021

(54) APPROACHING VEHICLE ALERT SYSTEM

(71) Applicant: Christopher Hawkins, Neosho, MO (US)

(72) Inventor: Christopher Hawkins, Neosho, MO (US)

(21) Appl. No.: 16/903,962

(22) Filed: Jun. 17, 2020

(51) Int. Cl. G08G 1/16; G08G 1/052; G08G 1/08; B60Q 9/00

(52) U.S. Cl. CPC G08G 1/166; B60Q 9/008; G08G 1/08; G08G 1/052

(57) ABSTRACT

An approaching vehicle alert system, including at least one alert transmitter to be removably disposed on at least a portion of at least one vehicle to broadcast an approaching signal, and at least one alert receiver removably disposed on at least a portion of a traffic sign to receive the approaching signal and use the approaching signal to detect a speed level of at least one other vehicle at an intersection moving in a different direction than the at least one vehicle, the at least one alert receiver including a body, and a plurality of illumination units disposed on at least a portion of the body to illuminate in response to a presence and an absence of the at least one other vehicle, and the speed level of the at least one other vehicle exceeding a predetermined speed level.

### BACKGROUND

### 1. Field

The present general inventive concept relates generally to an alert system, and particularly, to an approaching vehicle alert system.

### 2. Description of the Related Art

Currently, there are many people traveling on roads daily. However, major vehicle collisions are common and tend to occur at busy intersections due to various reasons, such as drivers not stopping at a stop sign, drivers not paying attention to the current traffic, and/or speeding. The lack of attention to driving by the drivers will often result in a severe accident that includes vehicle damage, property damage, and/or fatalities.

A stop sign is a traffic sign that includes the word “STOP” to indicate to a driver to stop at an intersection. However, the stop sign has no other means to alert the driver, other than relying on the driver's attention. It is well known that people have improved attention based on movement. In other words, an object in motion or a flashing light will draw attention from a viewer better than a stationary object and/or a static light.

Therefore, there is a need for an approaching vehicle alert system that insures the driver will notice the traffic sign at an intersection.

### SUMMARY

The present general inventive concept provides an approaching vehicle alert system.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing an approaching vehicle alert system, including at least one alert transmitter to be removably disposed on at least a portion of at least one vehicle to broadcast an approaching signal, and at least one alert receiver removably disposed on at least a portion of a traffic sign to receive the approaching signal and use the approaching signal to detect a speed level of at least one other vehicle at an intersection moving in a different direction than the at least one vehicle, the at least one alert receiver including a body, and a plurality of illumination units disposed on at least a portion of the body to illuminate in response to a presence and an absence of the at least one other vehicle, and the speed level of the at least one other vehicle exceeding a predetermined speed level.

The plurality of illumination units may be disposed on a recessed portion of the body.

The plurality of illumination units may illuminate a first color in response to the presence of the at least one other vehicle, and illuminate a second color in response to the absence of the at least one other vehicle.

The at least one alert receiver may further include a power source disposed on at least a portion of the body to provide power to the plurality of illumination units.

The at least one alert receiver may further include an audio unit disposed on at least a portion of the body to emit an alarm sound in response to the presence of the at least one other vehicle, and the speed level of the at least one other vehicle exceeding the predetermined speed level.

The audio unit may increase in volume in response to the at least one other vehicle decreasing in distance from the at least one alert receiver.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates an elevation view of an approaching vehicle alert system, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Approaching Vehicle Alert System 100
Alert Transmitter 110
Body 111
Communication Unit 112
Control Unit 113
Processing Unit 113a
Storage Unit 113b
Illumination Unit 114
Test Button 115
Power Button 116
Power Source 117
Fastener 118
Alert Receiver 120
Body 121
Illumination Units 122
Control Unit 123
Processing Unit 123a
Communication Unit 123b
Storage Unit 123c
Audio Unit 124
Power Source 125
Ventilation Aperture 126
Fastener 127

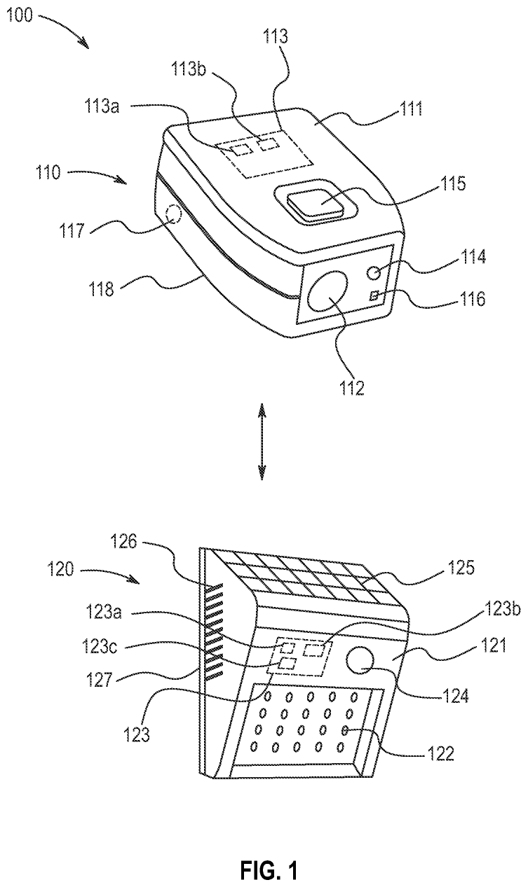

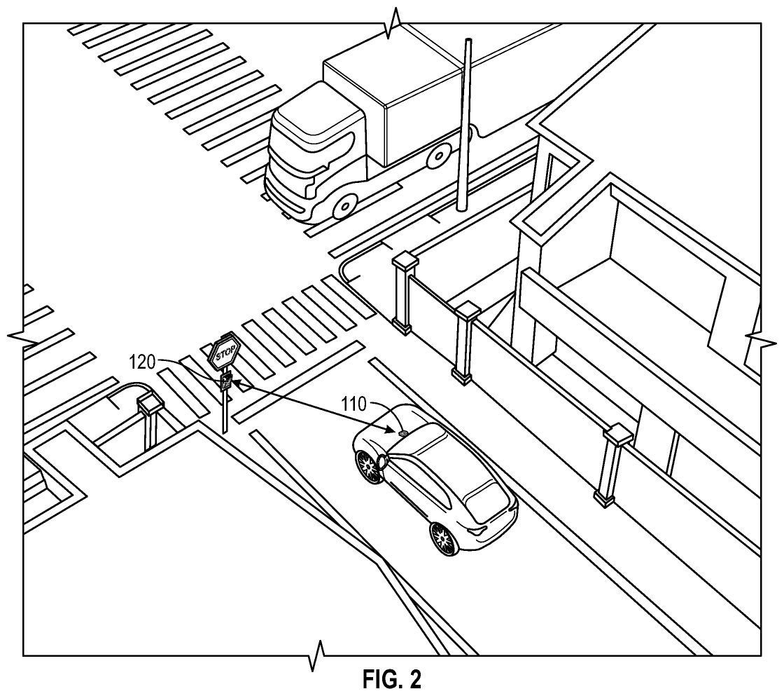

FIG. 1 illustrates an elevation view of an approaching vehicle alert system 100, according to an exemplary embodiment of the present general inventive concept.

The approaching vehicle alert system 100 may be constructed from at least one of metal, plastic, wood, and rubber, etc., but is not limited thereto.

The approaching vehicle alert system 100 may include at least one alert transmitter 110 and at least one alert receiver 120, but is not limited thereto.

The at least one alert transmitter 110 may include a body 111, a communication unit 112, a control unit 113, an illumination unit 114, a test button 115, a power button 116, a power source 117, and a fastener 118, but is not limited thereto.

The body 111 may have various sizes based on a preference of a user. For example, the body 111 may have a first predetermined size to fit on a rear view mirror of at least one vehicle, such as a car, a truck, a bus, and/or a van. Alternatively, the body 111 may have a second predetermined size to fit on a dashboard of the at least one vehicle. Also, the body 111 may have a third predetermined size to fit on a handlebar of a motorcycle and/or a bicycle.

As such, a size of the body 111 for the car, the truck, the bus, and/or the van may be larger than the size of the body 111 for the motorcycle and/or the bicycle. Also, the size of the body 111 for the car, the truck, the bus, and/or the van on the dashboard may be larger than the size of the body 111 for the rear view mirror of the at least one vehicle.

Furthermore, the at body 111 may be installed on a driveway of the user, depending on the preference of the user.

The communication unit 112 may include a device capable of wireless or wired communication between other wireless or wired devices via at least one of Wi-Fi, Wi-Fi Direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication, USB, Firewire, and Ethernet.

The communication unit 112 may be disposed on and/or within at least a portion of a front surface of the body 111.

The control unit 113 may include a processing unit 113a and a storage unit 113b, but is not limited thereto.

The control unit 113 may be disposed within at least a portion of the body 111 and may be electrically connected to the communication unit 112.

The processing unit 113a (or central processing unit, CPU) may include electronic circuitry to carry out instructions of a computer program by performing basic arithmetic, logical, control and input/output (I/O) operations specified by the instructions. The processing unit 113a may include an arithmetic logic unit (ALU) that performs arithmetic and logic operations, processor registers that supply operands to the ALU and store the results of ALU operations, and a control unit that fetches instructions from memory and “executes” them by directing the coordinated operations of the ALU, registers and other components. The processing unit 113a may also include a microprocessor and a microcontroller.

The storage unit 113b may include a random access memory (RAM), a read-only memory (ROM), a hard disk, a flash drive, a database connected to the Internet, cloud-based storage, Internet-based storage, or any other type of storage unit.

The storage unit 113b may store a program and/or an application to be executed using the processing unit 113a. For ease of description, the program and/or the application will hereinafter be referred to as an app. The app may be designed to control the control unit 113.

The processing unit 113a may run the app to broadcast an approaching signal from the communication unit 112. The processing unit 113a may send a steady signal and/or a periodic signal (i.e. intermittent) based on a predetermined setting in the app. In other words, the approaching signal may be steady and/or periodic.

The illumination unit 114 may include a light, but is not limited thereto.

The illumination unit 114 may be disposed on and/or within at least a portion of the front surface of the body 111. The illumination unit 114 may be a light-emitting diode (LED) and/or an incandescent bulb.

The test button 115 may be disposed on at least a portion of a top surface and/or a bottom surface of the body 111. The illumination unit 114 may illuminate in response to the test button 115 being depressed. As such, the test button 115 may be depressed to indicate correct operation of the communication unit 112 and/or the control unit 113.

Moreover, the illumination unit 114 may illuminate a first color, a steady light, and/or a flashing light in response to the communication unit 112 and/or the control unit 113 operating correctly. Additionally, the illumination unit 114 may illuminate a second color, the steady light, and/or the flashing light in response to the communication unit 112 and/or the control unit 113 operating incorrectly. For example, the illumination unit 114 may illuminate a second color, the steady light and/or the flashing light in response to the communication unit 112 and/or the control unit 113 not transmitting signals and/or having defective wiring.

The power button 116 may be disposed on at least a portion of the front surface of the body 111. However, the power button 116 may be disposed on any portion of the body 111. The power button 116 may turn on and/or turn off the communication unit 112, the control unit 113, the illumination unit 114, and/or the test button 115.

The power source 117 may include a battery and a solar cell, but is not limited thereto. The battery may include lithium-ion, nickel cadmium, nickel metal hydride, alkaline, etc., but is not limited thereto.

The power source 117 may be disposed within at least a portion of the body 111. The power source 117 may provide power to the communication unit 112, the control unit 113, the illumination unit 114, the test button 115, and/or the power button 116, but is not limited thereto.

The fastener 118 may include an adhesive (e.g., glue or tape), a hook and loop, a magnet, a clasp, a clamp, a wire, and a hook, but is not limited thereto. For example, the fastener 118 may include 3M Scotch 4950 VHB double-sided tape.

The fastener 118 may be disposed on at least a portion of the bottom surface of the body 111. The fastener 118 may facilitate connecting the body 111 to the rear view mirror of the at least one vehicle and/or the dashboard of the at least one vehicle. Additionally, the fastener 118 may prevent the body 111 from being removed from the at least one vehicle without a predetermined amount of force and/or manipulation of the fastener 118. However, the body 111 may be removably disposed on at least a portion of the at least one vehicle.

The at least one alert receiver 120 may include a body 121, a plurality of illumination units 122, a control unit 123, an audio unit 124, a power source 125, at least one ventilation aperture 126, and a fastener 127, but is not limited thereto.

The at least one alert receiver 120 may be removably disposed on a traffic sign, such as a stop sign, but any surface may be used.

Referring to FIG. 1, the body 121 is illustrated to have a triangular shape. However, the body 121 may be a rectangular prism, circular, spherical, conical, pentagonal, hexagonal, heptagonal, octagonal, and/or any other shape known to one of ordinary skill in the art. Also, a front surface of the body 121 may protrude away from a rear surface of the body 121.

The body 121 may have a predetermined size, such as three inches by three inches. However, the body 121 may be any size based on needs of a community.

Each of the plurality of illumination units 122 may include a light, but is not limited thereto.

The plurality of illumination units 122 may be disposed on at least a portion of a bottom portion of the front surface of the body 121. Each of the plurality of illumination units 122 may be an LED and/or an incandescent bulb. Moreover, the plurality of illumination units 122 may be disposed on a recessed portion of the front surface of the body 121. More specifically, a center of the front surface of the body 121 may protrude away from the rear surface of the body 121 greater than the recessed portion of the body 121 protrudes away from the rear surface of the body 121. As such, the plurality of illumination units 122 may be recessed with respect to the front surface of the body 121. Accordingly, the plurality of illumination units 122 may be protected from inclement weather, such as rain, snow, sleet, and/or hail.

The control unit 123 may include a processing unit 123a, a communication unit 123b, and a storage unit 123c, but is not limited thereto.

The control unit 123 may be disposed within at least a portion of the body 121.

The processing unit 123a (or central processing unit, CPU) may include electronic circuitry to carry out instructions of a computer program by performing basic arithmetic, logical, control and input/output (I/O) operations specified by the instructions. The processing unit 123a may include an arithmetic logic unit (ALU) that performs arithmetic and logic operations, processor registers that supply operands to the ALU and store the results of ALU operations, and a control unit that fetches instructions from memory and “executes” them by directing the coordinated operations of the ALU, registers and other components. The processing unit 123a may also include a microprocessor and a microcontroller.

The communication unit 123b may include a device capable of wireless or wired communication between other wireless or wired devices via at least one of Wi-Fi, Wi-Fi Direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication, USB, Firewire, and Ethernet.

The storage unit 123c may include a random access memory (RAM), a read-only memory (ROM), a hard disk, a flash drive, a database connected to the Internet, cloud-based storage, Internet-based storage, or any other type of storage unit.

The storage unit 123c may store the app described above with respect to the control unit 113. The app may be designed to control the control unit 123, but the app may control the control unit 123 different than the control unit 113.

The processing unit 123a may run the app to send a command to the communication unit 123b to scan for and/or receive the approaching signal from the communication unit 112. The processing unit 123a may also detect and/or monitor for a presence of at least one other vehicle at the intersection moving in a different direction than the at least one vehicle (i.e. cross-traffic) to determine a likelihood of danger when the user crosses the intersection at the same time.

As such, the processing unit 123a may determine the control unit 113 (and therefore the at least one vehicle) may be approaching the processing unit 123a based on a proximity (i.e. distance away from) and/or a strength of the approaching signal received by the communication unit 123b. For example, the processing unit 123a may receive the approaching signal in response to the control unit 113 being within 450 feet away.

Moreover, the processing unit 123a may activate the plurality of illumination units 122 based on the proximity, a speed level of the at least one other vehicle, and/or existing cross-traffic of the at least one other vehicle, such that the speed level of the at least one other vehicle is based on a detected change in distance of the control unit 113 to the processing unit 123a. Additionally, the processing unit 123a may compare the speed level of the at least one other vehicle to a predetermined speed level stored on the storage unit 123c, such that the plurality of illumination units 122 may illuminate in response to the speed level of the at least one other vehicle exceeding the predetermined speed level. As such, the plurality of illumination units 122 may alert the user that a speed to an intersection is too fast and is at risk of driving past a stop sign, such that the user may collide with the at least one other vehicle in the cross-traffic. In other words, the processing unit 123a may keep the plurality of illumination units 122 off in response to the speed level of the at least one vehicle of the user being below the predetermined speed level, which indicates the at least one vehicle of the user is stopping and/or has already stopped at the stop sign.

Also, the plurality of illumination units 122 may illuminate a third color (i.e. red), a steady light, and/or a flashing light in response to the processing unit 123a detecting the speed level of the at least one other vehicle exceeds the predetermined speed level. The plurality of illumination units 122 may illuminate a fourth color (i.e. green), the steady light, and/or the flashing light in response to the processing unit 123a detecting an absence of the at least one other vehicle and/or for vehicles stopping and/or have already stopped for the stop sign. Alternatively, the plurality of illumination units 122 may illuminate the fourth color to indicate the intersection is clear and safe for the user to cross.

The audio unit 124 may include a speaker, but is not limited thereto.

The audio unit 124 may be disposed on at least a portion of the body 121. Moreover, the processing unit 123a may activate the audio unit 124 based on the proximity, the speed level of the at least one other vehicle, and/or the existing cross-traffic of the at least one other vehicle, as described above. Additionally, the processing unit 123a may compare the speed level of the at least one other vehicle to the predetermined speed level stored on the storage unit 123c, such that the audio unit 124 may emit an alarm sound in response to the speed level of the at least one other vehicle exceeding the predetermined speed level. As such, the audio unit 124 may alert the user that the speed to the intersection is too fast and is at risk of driving past the stop sign, such that the user may collide with the at least one other vehicle in the cross-traffic. In other words, the processing unit 123a may keep the audio unit 124 off in response to the speed level of the at least one vehicle of the user being below the predetermined speed level, which indicates the at least one vehicle of the user is stopping at the stop sign.

Also, the audio unit 124 may emit the alarm sound at various sound levels in response to the processing unit 123a detecting the speed level of the at least one other vehicle exceeds the predetermined speed level and/or based on a distance of the control unit 113 is to the processing unit 123a. For example, the audio unit 124 may increase in volume in response to the speed level of the at least one other vehicle exceeding the predetermined speed level and/or the distance of the control unit 113 to the processing unit 123a decreasing. In other words, the audio unit 124 may emit the alarm sound at 100 feet from the control unit 113 that is louder than the alarm sound at 450 feet from the control unit 113. Alternatively, the audio unit 124 may remain off in response to the processing unit 123a detecting the absence of the at least one other vehicle and/or for vehicles stopping and/or have already stopped for the stop sign

The power source 125 may include a solar cell and a battery, but is not limited thereto. The battery may include lithium-ion, nickel cadmium, nickel metal hydride, alkaline, etc., but is not limited thereto.

The power source 125 may be disposed within at least a portion of the body 121. The power source 125 may provide power to the plurality of illumination units 122, the control unit 123, and/or the audio unit 124, but is not limited thereto.

The at least one ventilation aperture 126 may be disposed on at least a portion of the body 121. The at least one ventilation aperture 126 may facilitate movement of air therethrough, such that an interior portion of the body 121 may cool down.

The fastener 127 may include an adhesive (e.g., glue or tape), a hook and loop, a magnet, a clasp, a clamp, a wire, and a hook, but is not limited thereto. For example, the fastener 127 may include 3M Scotch 4950 VHB double-sided tape.

The fastener 127 may be disposed on at least a portion of the bottom surface of the body 121. The fastener 127 may facilitate connecting the body 121 to the traffic sign. Additionally, the fastener 127 may prevent the body 121 from being removed from the traffic sign without a predetermined amount of force and/or manipulation of the fastener 127. However, the body 121 may be removably disposed on at least a portion of the traffic sign.

Therefore, the approaching vehicle alert system 100 may prevent collisions of vehicles by alerting drivers at the stop sign of a rapidly approaching vehicle to the intersection.

The present general inventive concept may include an approaching vehicle alert system 100, including at least one alert transmitter 110 to be removably disposed on at least a portion of at least one vehicle to broadcast an approaching signal, and at least one alert receiver 120 removably disposed on at least a portion of a traffic sign to receive the approaching signal and use the approaching signal to detect a speed level of at least one other vehicle at an intersection moving in a different direction than the at least one vehicle, the at least one alert receiver 120 including a body 121, and a plurality of illumination units 122 disposed on at least a portion of the body 121 to illuminate in response to a presence and an absence of the at least one other vehicle, and the speed level of the at least one other vehicle exceeding a predetermined speed level.

The plurality of illumination units 122 may be disposed on a recessed portion of the body 121.

The plurality of illumination units 122 may illuminate a first color in response to the presence of the at least one other vehicle, and illuminate a second color in response to the absence of the at least one other vehicle.

The at least one alert receiver 120 may further include a power source 125 disposed on at least a portion of the body 121 to provide power to the plurality of illumination units 122.

The at least one alert receiver 120 may further include an audio unit 124 disposed on at least a portion of the body 121 to emit an alarm sound in response to the presence of the at least one other vehicle, and the speed level of the at least one other vehicle exceeding the predetermined speed level.

The audio unit 124 may increase in volume in response to the at least one other vehicle decreasing in distance from the at least one alert receiver 120.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. An approaching vehicle alert system, comprising:
at least one alert transmitter to be removably disposed on at least a portion of at least one vehicle to broadcast an approaching signal; and
at least one alert receiver removably disposed on at least a portion of a traffic sign to receive the approaching signal and use the approaching signal to detect a speed level of at least one other vehicle at an intersection moving in a different direction than the at least one vehicle, the at least one alert receiver comprising:
a body, and
a plurality of illumination units disposed on at least a portion of the body to illuminate in response to a presence and an absence of the at least one other vehicle, and the speed level of the at least one other vehicle exceeding a predetermined speed level, such that the plurality of illumination units illuminate in response to the at least one receiver determining a collision will occur in cross-traffic based on a speed level of the at least one vehicle approaching the intersection and the speed level of the at least one other vehicle moving toward the intersection.

2. The approaching vehicle alert system of claim 1, wherein the plurality of illumination units are disposed on a recessed portion of the body.

3. The approaching vehicle alert system of claim 1, wherein the plurality of illumination units illuminate a first color in response to the presence of the at least one other vehicle, and illuminate a second color in response to the absence of the at least one other vehicle.

4. The approaching vehicle alert system of claim 1, wherein the at least one alert receiver further comprises:
a power source disposed on at least a portion of the body to provide power to the plurality of illumination units.

5. The approaching vehicle alert system of claim 1, wherein the at least one alert receiver further comprises:
an audio unit disposed on at least a portion of the body to emit an alarm sound in response to the presence of the at least one other vehicle, and the speed level of the at least one other vehicle exceeding the predetermined speed level.

6. The approaching vehicle alert system of claim 5, wherein the audio unit increases in volume in response to the at least one other vehicle decreasing in distance from the at least one alert receiver.

7. An approaching vehicle alert system, comprising:
at least one alert transmitter to be removably disposed on at least a portion of at least one vehicle to broadcast an approaching signal; and
at least one alert receiver removably disposed on at least a portion of a traffic sign to receive the approaching signal and use the approaching signal to detect a speed level of at least one other vehicle at an intersection moving in a different direction than the at least one vehicle, the at least one alert receiver comprising:
a body, and
a plurality of illumination units disposed on at least a portion of the body to illuminate in response to a detection of a presence of the at least one other vehicle traveling at a predetermined speed, such that the plurality of illumination units do not illuminate, upon detection of the at least one other vehicle when the at least one other vehicle is in process of stopping, such that the plurality of illumination units illuminate in response to the at least one receiver determining a collision will occur in cross-traffic based on a speed level of the at least one vehicle approaching the intersection and the speed level of the at least one other vehicle moving toward the intersection.
